(19) United States
(12) Patent Application Publication
(10) Pub. No.: US 2018/0203457 A1
(43) Pub. Date: Jul. 19, 2018

(54) System and Method for Avoiding Interference with a Bus

(71) Applicant: Ford Global Technologies, LLC, Dearborn, MI (US)

(72) Inventors: Maryam Moosaei, Mountain View, CA (US); Jinesh J. Jain, Palo Alto, CA (US); Harpreetsingh Banvait, San Jose, CA (US)

(21) Appl. No.: 15/406,121

(22) Filed: Jan. 13, 2017

(51) Int. Cl. G05D 1/02; G05D 1/00; G08G 1/123; G06N 3/08; G06N 3/04

(52) U.S. Cl. CPC G05D 1/0246; G05D 1/0088; G06N 3/04; G06N 3/08; G08G 1/123

(57) ABSTRACT

A method for avoiding interference with a bus. The method includes detecting a bus and obtaining image data from the bus, such as information displayed on the bus. A deep neural network trained on bus images may process the information to associate the bus with a bus route and stop locations. Map data corresponding to the stop locations may also be obtained and used to initiate a lane change or safety response in response to proximity of the bus to a stop location. A corresponding system and computer program product is also disclosed and claimed herein.

### BACKGROUND

### Field of the Invention

This invention relates to vehicle navigation systems.

### Background of the Invention

Modern transportation systems provide an immense public service by facilitating convenient transportation to commuters at minimal expense and environmental impact. In most moderate to large cities, bus transportation enables passengers to almost pinpoint their destinations to within walking distance. Since buses run according to a scheduled timetable with predetermined stops, commuters can plan their trips with confidence that they will reach their destinations on time. Additionally, bus systems strive to meet demand by increasing the frequency of buses during periods of heavy use.

While a boon to society at large, buses are often viewed with disdain by unlucky drivers that happen to get stuck behind them in traffic. Attentive drivers may be aware of bus stop locations and attempt to anticipate bus activity to avoid unwanted slowing and interference. Good drivers also exercise added caution when in proximity to a stopped bus to avoid problems with pedestrians.

Although still under development, autonomous vehicles are anticipated as providing a safe and convenient alternative to traditional modes of transportation. Like other modes of transportation, however, efficiencies associated with autonomous vehicle usage may depend on the ability of autonomous vehicles to anticipate and avoid obstacles and other sources of traffic congestion, including buses and pedestrians.

Accordingly, what are needed are systems and methods for autonomous vehicles to automatically detect and avoid interference with buses. Ideally, such systems and methods would enable autonomous vehicles to distinguish between different types of buses, including public buses, private buses, shuttle buses, and school buses, to determine an appropriate strategy for avoidance. Such systems and methods may also anticipate bus stops along a bus route to promote safety in navigating around a bus and avoiding pedestrians.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level schematic diagram of an autonomous vehicle and bus in accordance with the invention;

FIG. 2 shows modules for providing various features and functions of a system in accordance with certain embodiments of the invention;

FIG. 3 is a front perspective view of one embodiment of a bus in accordance with the invention;

FIG. 4 is a rear perspective view of the bus depicted in FIG. 3;

FIG. 5 is a top view of a map depicting one embodiment of a system for avoiding a bus in accordance with the invention;

FIG. 6 is a top view of a map depicting a second embodiment of a system for avoiding a bus in accordance with the invention; and

FIG. 7 is a flow chart depicting a process for avoiding a bus in accordance with certain embodiments of the invention.

### DETAILED DESCRIPTION

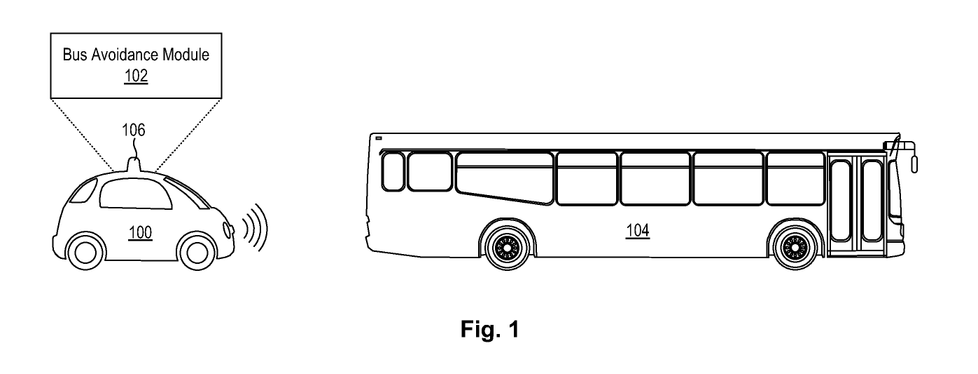

Referring to FIG. 1, successfully navigating a vehicle in traffic requires an understanding and awareness of surrounding vehicles and environmental conditions. Through education and experience, human drivers typically acquire the skills needed to navigate traffic at acceptable levels of proficiency before receiving a license to drive independently. As autonomous vehicles become increasingly present on public roads, they too need to be able to safely and efficiently navigate public roads and avoid obstacles and other traffic, including buses.

The nature of autonomous vehicles requires almost constant surveillance of surrounding environmental conditions using various vehicle sensors. While these sensors may provide the vehicle with information needed to navigate traffic generally, current autonomous vehicles may be ill-equipped to distinguish buses from other different types of vehicle traffic and to select an appropriate vehicle response. Systems and methods in accordance with the present invention address this issue and, more particularly, facilitate an autonomous vehicle's ability to identify and distinguish between types of buses to safely and to avoid them as appropriate.

Specifically, as shown in FIG. 1, in certain embodiments, an autonomous or semi-autonomous vehicle 100 may be provided to transport people or cargo to various locations and to navigate roads and traffic with little or no human intervention. During the course of this transport, the autonomous vehicle 100 may need to avoid various obstacles, such as other vehicles, people, animals, hazards, and the like. It may also be advantageous to avoid objects that may slow or impede progress of the autonomous vehicle 100. For example, buses 104 or other vehicles providing mass transportation are known to stop frequently and impede the progress of other vehicles behind them. In some cases, laws may prohibit passing a bus 104 after it has stopped to pick up or drop off passengers. Once stuck behind a bus 104, it may be difficult for an autonomous vehicle 100 to navigate around the bus 104 or to merge into traffic in other lanes. Thus it would be advantageous to be able to anticipate stopping of a bus 104 and navigate around or avoid the bus 104 prior to it slowing or stopping.

In certain embodiments, an autonomous vehicle 100 in accordance with the invention may include a bus avoidance module 102 to assist the autonomous vehicle in avoiding the bus 104 or other mass transit vehicle. The bus avoidance module 102 may interface with various sensors 106 associated with the autonomous vehicle 100 to detect and recognize a bus 104 proximate the autonomous vehicle 100. These sensors 106 may include, for example, camera sensors, lidar sensors, radar sensors, ultrasound sensors, or the like.

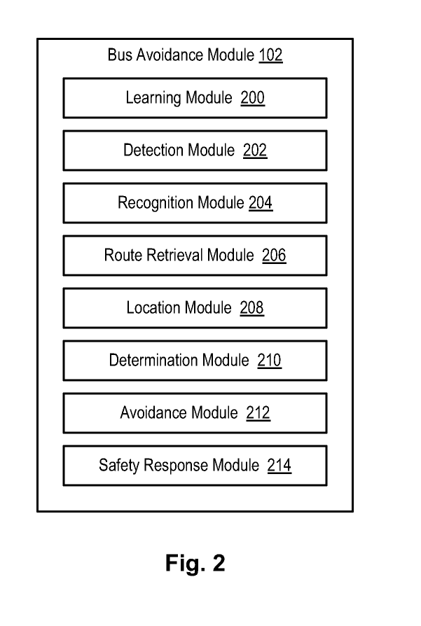

Once a bus 104 has been recognized, the bus avoidance module 102 may retrieve route data associated with the bus 104 to determine where the bus 104 may stop to receive or drop off passengers. Ideally, this will enable the autonomous vehicle 100 to navigate around or otherwise avoid the bus 104 before it has stopped or begins to slow. Alternatively, the bus avoidance module 102 may recognize upcoming bus stops on the road on which it is traveling and navigate around or otherwise avoid the bus 104 before it comes to a stop. The function of the bus avoidance module 102 will be discussed in more detail with reference to FIG. 2.

Referring now to FIG. 2, the bus avoidance module 102 discussed above may include various sub-modules to provide various features and functions. The bus avoidance module 102 and associated sub-modules may be implemented in hardware, software, firmware, or combinations thereof. As shown, the bus avoidance module 102 may include one or more of a learning module 200, detection module 202, recognition module 204, route retrieval module 206, location module 208, determination module 210, avoidance module 212, and safety response module 214. The sub-modules within the bus avoidance module 102 are provided by way of example and are not intended to represent an exhaustive list of sub-modules that may be included within the bus avoidance module 102. The bus avoidance module 102 may include more or fewer sub-modules than those illustrated, or the sub-modules may be organized differently. For example, the functionality of a sub-module may be divided into multiple sub-modules, or the functionality of several sub-modules may be combined into a single sub-module.

In certain embodiments, the learning module 200 may receive image input data depicting various types of buses, such as public or city buses, private or chartered buses, shuttle buses, school buses, and the like. The learning module 200 may utilize deep neural networks or similar deep learning architectures to process the image input data and distinguish buses 104 from other types of vehicles, and to identify different types of buses 104 within the general category of “bus”.

The learning module 200 may further receive various image input data of information displayed on a bus 104, such as bus numbers and codes, route numbers, route descriptions, and/or license plates visible to an exterior environment. In some embodiments, this information may be displayed on LED displays or screens on the exterior of the bus 104 or visible through one or more windows or windshields on an interior of the bus 104. In other embodiments, such information may be otherwise printed or electronically displayed on the bus 104. The learning module 200 may input this information into deep neural networks or other deep learning architectures to train embodiments of the invention to recognize the displayed information and to correlate the information with other data as needed.

The detection module 202 may detect a bus 104 utilizing data gathered from sensors 106 associated with an autonomous vehicle 100. As previously mentioned, data from sensors 106 associated with the autonomous vehicle 100 may include image data, lidar data, radar data, ultrasound data, and the like. The detection module 202 may further detect identifying information displayed on the exterior of a bus 104, such as a bus number or code, route number, and/or route description.

The recognition module 204 may receive the information detected by the detection module 202 and process the data through a deep neural network, for example, to recognize the bus 104 and distinguish it from other types of vehicles in the surrounding environment. The recognition module 204 may further receive identifying information displayed on the exterior of the bus 104 and detected by the detection module 202. The recognition module 204 may utilize deep learning architectures to recognize the content of the identifying information and identify it as a bus number or code, a route number, a route description, or the like.

In some embodiments, a route retrieval module 206 may retrieve route information associated with an identified bus 104 from a server or cloud platform, for example. Route information may include expected times and locations of bus 104 stops, as well as an anticipated route of travel. The route retrieval module 206 may pair route information with the bus 104 to facilitate an appropriate vehicle response based on scheduled bus 104 activity.

The location module 208 may utilize information gathered from various vehicle sensors 106 to determine a location of the autonomous vehicle 100 relative to the bus 104, as well as to determine the geographic location of the autonomous vehicle 100 on a map. For example, the location module 208 may access global positioning system (GPS) data to pinpoint geographic coordinates corresponding to the autonomous vehicle 100, as well as to locate the autonomous vehicle 100 relative to roads, bus 104 routes, bus 104 stops and other map data and features of the surrounding environment. The location module 208 may operate in conjunction with a determination module 210 to evaluate courses of action that the autonomous vehicle 100 may take to avoid interference with the bus 104.

In one embodiment, for example, the determination module 210 may ascertain whether the bus 104 is approaching a bus 104 stop. The determination module 210 may further determine a distance between the autonomous vehicle 100 and the bus 104 and in some embodiments, between the bus 104 and the bus 104 stop. In some embodiments, the determination module 210 may communicate with sensors 106 of the autonomous vehicle 100 to determine such distances, as well as to assess other conditions of the surrounding environment.

In one embodiment, for example, data gathered from camera and/or radar sensors 106 associated with the autonomous vehicle 100 may indicate heavy traffic in adjacent lanes. The determination module 210 may use this information to selectively exclude a lane change as an otherwise appropriate course of action for the autonomous vehicle 100 to avoid interference with the bus 104.

The avoidance module 212 may communicate with the determination module 210 to initiate a course of action recommended by the determination module 210. In one embodiment, for example, the determination module 210 may determine that there is sufficient distance between the autonomous vehicle 100 and the bus 104 and sparse surrounding traffic. The determination module 210 may thus determine that the autonomous vehicle 100 may safely pass the bus 104 by changing lanes. In response, the avoidance module 212 may perform a lane changing algorithm to initiate a lane change.

In another embodiment, such as where there is insufficient distance between the autonomous vehicle 100 and the bus 104 or where the autonomous vehicle 100 is approaching an intersection, the avoidance module 212 may slow the autonomous vehicle 100 prior to initiating the lane change. In other embodiments, the avoidance module 212 may initiate an alternate route of travel to allow the autonomous vehicle 100 to avoid the bus 104.

The safety response module 214 may also communicate with the determination module 210 and/or the avoidance module 212 to initiate a safety response, such as activating the brakes of the autonomous vehicle 100 where there is an increased probability of encountering pedestrian traffic or other potential safety concerns.

In one embodiment, for example, the determination module 210 may determine that the autonomous vehicle 100 is in close proximity to a bus 104, and that the bus 104 is quickly approaching a bus 104 stop. As a result, there may be a high likelihood that the autonomous vehicle 100 may encounter pedestrians, and may be required to slow to a stop. Accordingly, the safety response module 214 may immediately reduce the speed of the autonomous vehicle 100 to create distance between the autonomous vehicle 100 and the bus 104. The safety response module 214 may cause the autonomous vehicle 100 to maintain that distance and exercise increased caution as the autonomous vehicle 100 and bus 104 approach the bus 104 stop. In some embodiments, the safety response module 214 may also initiate a pedestrian detection algorithm to facilitate early detection and avoidance of pedestrians in the immediate vicinity.

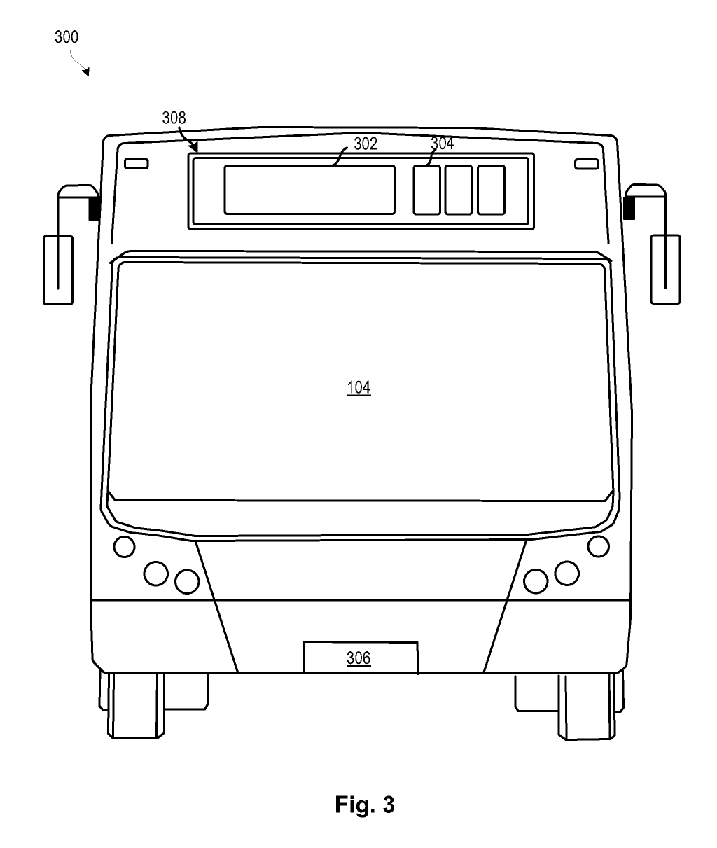

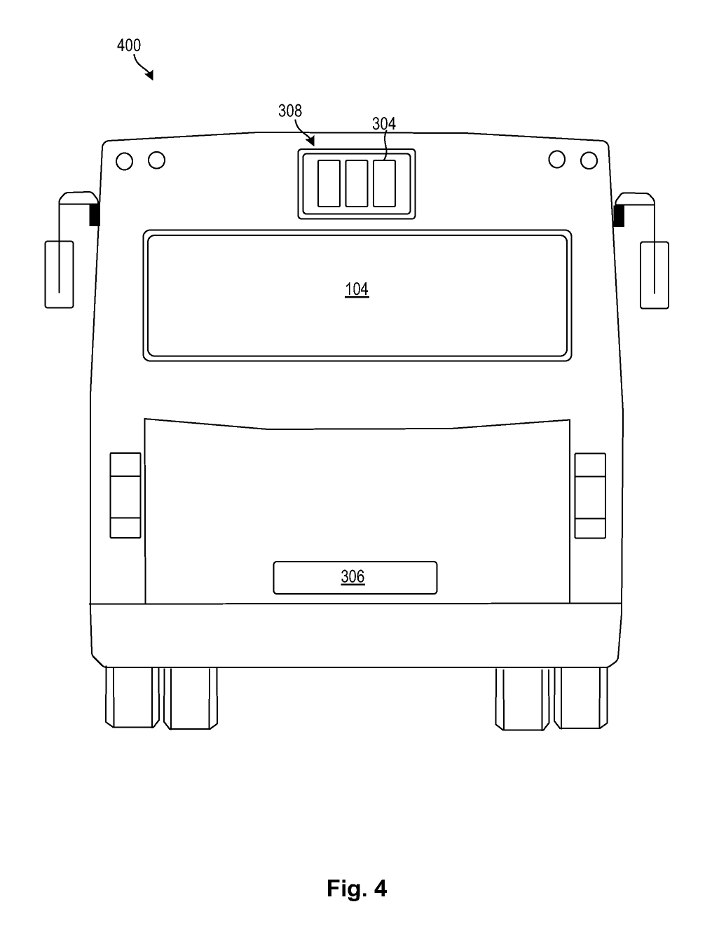

Referring now to FIGS. 3 and 4, an autonomous vehicle 100 in accordance with embodiments of the present invention may utilize one or more computer vision techniques in conjunction with various sensors 106 to detect and recognize various types of buses and accompanying identifying indicia. In certain embodiments, for example, an autonomous vehicle 100 may be equipped with sensors 106 configured to detect features of a surrounding environment, including other vehicles. As previously mentioned, the sensors 106 may include camera sensors, radar sensors, lidar sensors, ultrasound sensors, and other such sensors 106 configured to gather image data.

The image data may be received for subsequent processing by a processor associated with the autonomous vehicle 100. The processor may utilize a deep neural network or other similar architecture to recognize identifying indicia displayed on a bus 104. In some embodiments, for example, the processor may utilize a deep neural network trained on images of bus 104 codes, bus 104 numbers, bus 104 number plates, and the like, to recognize identifying information displayed on the bus 104.

In one embodiment, as shown in FIG. 3, one or more sensors 106 associated with the autonomous vehicle 100 may detect a bus 104 at an intersection, where the front end 300 of the bus 104 is visible to the autonomous vehicle 100. This may occur, for example, where the bus 104 is making a turn onto the same road in the same that the autonomous vehicle 100 is traveling. The sensors 106 may gather image data as well as other data containing measurements and proportions of the bus 104. This information may be received by a processor associated with the autonomous vehicle 100 and trained to distinguish buses 104 from cars and other vehicular traffic. The processor may further identify the bus 104 as one of several types of buses including public buses, private buses, shuttle buses, school buses, and the like.

Sensors 106 of the autonomous vehicle 100 may be used in conjunction with various computer vision techniques to target identifying information displayed on or otherwise visible from an exterior of the bus 104. Such identifying information may include, for example, printed, digital, or other signage 308. As shown, the signage 308 may include information such as bus 104 or route description information 302, bus 104 code information 304, bus 104 number or license plate information 306, or the like. This information may be received by a processor of the autonomous vehicle 100 trained to analyze and recognize the identifying information displayed by the signage 308.

In other embodiments, as shown in FIG. 4, one or more sensors 106 associated with an autonomous vehicle 100 may detect a bus 104 traveling directly or indirectly ahead of the autonomous vehicle 100. In this case, the rear end 400 of the bus 104 may be visible to the autonomous vehicle 100. The rear end 400 of the bus 104 may contain identifying indicia including printed, digital, or other signage 308. As shown, such signage 308 may include bus 104 code information 304 or bus 104 license plate information 306. In other embodiments, however, the signage 308 may further include bus 104 description information 302, or any other identifying indicia known to those in the art.

In any event, sensors 106 may be implemented in conjunction with computer vision techniques utilized by the processor of the autonomous vehicle 100, and specifically with deep neural networks implemented by the autonomous vehicle 100 processor and/or servers or processors located external to the autonomous vehicle 100 (such as cloud servers, etc.), to capture, process, and recognize this information.

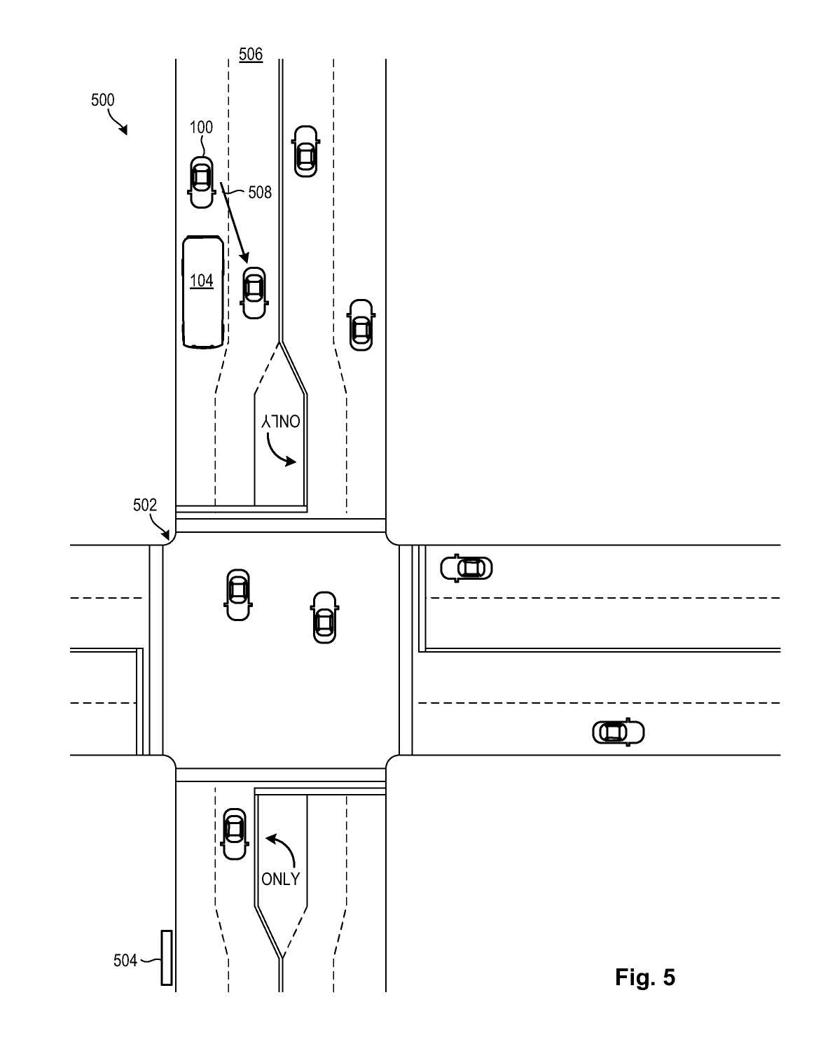

Referring now to FIG. 5, the autonomous vehicle 100 may communicate with a server or cloud database to retrieve route information associated with the identifying indicia from the bus 104. Route information may include, for example, an expected travel route, bus 104 stops 504, and stop 504 times associated with bus 104 travel. The autonomous vehicle 100 may further gather location data from GPS and other sensors 106 associated with the autonomous vehicle 100. This location data may be correlated with the route information to generate substantially real-time predictive information that may be used to predict bus 104 behavior and anticipate potential stops and/or hazards associated with the bus 104 as it travels on its route. Based on this information, the autonomous vehicle 100 may initiate action to avoid interference with the bus 104 or passengers boarding or exiting the bus 104.

In one embodiment, for example, as shown on the map 500, the autonomous vehicle 100 may be traveling directly behind a public city bus 104. Predictive information generated in accordance with the present invention may indicate that the bus 104 is approaching a bus 104 stop 504 immediately following an intersection 502. Sensors 106 associated with the vehicle 100 may indicate that there is no traffic in the adjacent lane 506. Based on this information, embodiments of the present invention may initiate a lane change 508 to overtake the bus 104 prior to reaching the intersection 502. In this manner, the autonomous vehicle 100 may avoid slowing, pedestrians, and other hazards that may otherwise occur as the bus 104 approaches the bus 104 stop 504.

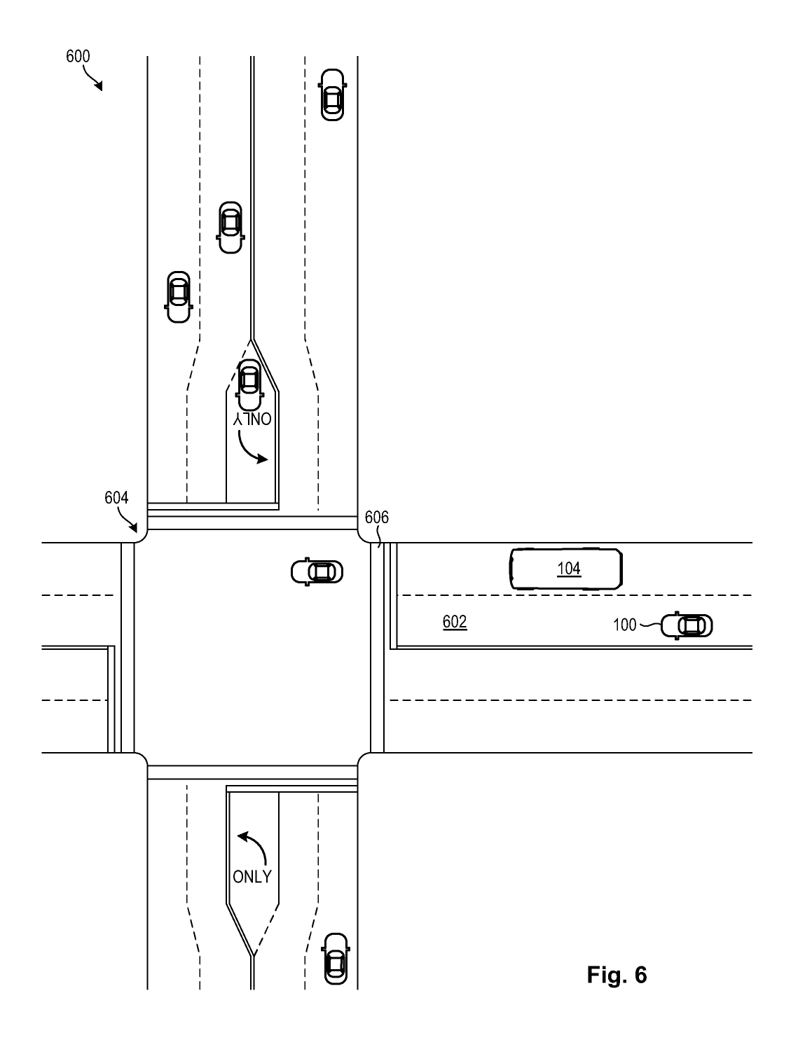

Referring now to FIG. 6, in another embodiment, as shown on the map 600, the autonomous vehicle 100 may be traveling in a lane 602 substantially adjacent to and behind a school bus 104. Predictive information generated in accordance with the invention may indicate that the bus 104 is approaching an intersection 604 having a pedestrian crosswalk 606. While sensors 106 associated with the vehicle 100 may indicate that there is no traffic directly ahead of the autonomous vehicle 100, overtaking the bus 104 may be excluded as an appropriate response for the autonomous vehicle 100 to take based on the proximity of the pedestrian crosswalk 606 and the unpredictable stopping nature of a school bus 104. As a result, embodiments of the present invention may instead reduce the speed of the autonomous vehicle 100 to maintain distance between the autonomous vehicle 100 and the bus 104. Various additional algorithms may also be implemented to increase the degree of caution exercised by the autonomous vehicle 100 as it approaches the intersection 604. Once the autonomous vehicle 100 has safely made it through the intersection 604, embodiments of the invention may re-evaluate an appropriate course of action for the autonomous vehicle 100 to avoid the school bus 104 and hazards and inconveniences associated therewith.

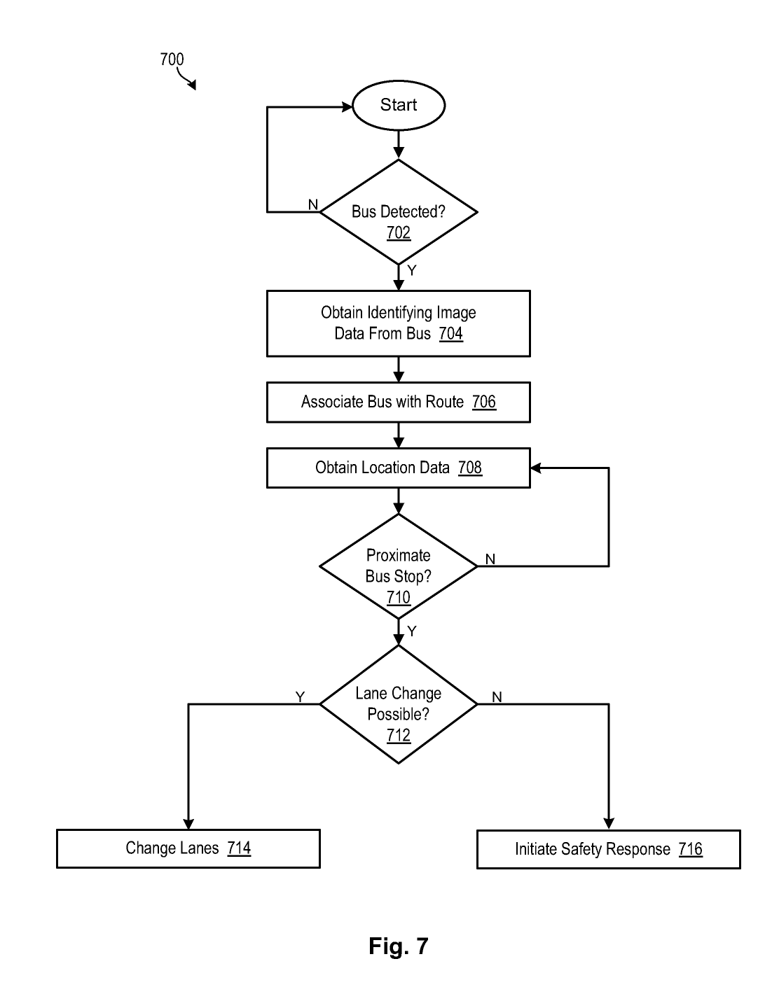

Referring now to FIG. 7, a method 700 in accordance with embodiments of the invention may detect 702 a bus 104 traveling in proximity to an autonomous vehicle 100. As previously discussed, a bus 104 may be detected 702 by processing information gathered from sensors 106 of the autonomous vehicle 100. In some embodiments, processing the information may include utilizing a deep neural network trained on images of various buses. If no bus 104 is detected, the method 700 may continue to monitor the environment until a bus 104 is detected 702.

If a bus 104 is detected 702, identifying image data may be obtained 704 from the bus 104. Specifically, camera sensors 106 and other autonomous vehicle 100 sensors 106 may gather image data from areas of the bus 104 used to display identifying information. In certain embodiments, for example, identifying information may be gathered from a screen or display area above the windshield of the front end 300 or rear end 400 of the bus 104. In other embodiments, identifying information may be gathered from a screen or display above or in a side window. In still other embodiments, identifying information may be gathered from a number or license plate 306 located near the bottom of a front end 300 or rear end 400 of the bus 104.

In any case, this identifying information may include bus 104 route information, bus 104 number information, bus 104 code information, bus 104 license plate information, or the like. The identifying information may be processed in accordance with the invention to recognize the information and associate 706 it with bus 104 route information. In some embodiments, bus 104 route information may be retrieved from a server or cloud-based database.

Location data may then be obtained 708 from GPS and other sensors 106 of the autonomous vehicle 100. The location data may be correlated with the bus 104 route information to determine 710 a proximity of the autonomous vehicle 100 and/or bus 104 to anticipated bus 104 stops. If neither the autonomous vehicle 100 nor bus 104 is in proximity to a bus 104 stop, the method 700 may continue to monitor the autonomous vehicle 100 and obtain 708 location data therefrom. If the autonomous vehicle 100 and/or bus 104 is in the vicinity of a bus 104 stop (e.g., approaching or leaving a bus 104 stop 504), the method 700 may query 712 whether a lane change is possible.

The feasibility of a lane change may depend on a number of factors including, for example, the number of lanes adjacent to the autonomous vehicle 100, other traffic traveling in close proximity to the autonomous vehicle 100 in those lanes, and whether there are other potential hazards associated with a lane change such as an upcoming pedestrian crosswalk 606, traffic light, or bus 104 stop, as discussed in detail above. These factors may be taken into account by performing various algorithms during the processing of the information to determine 712 whether a lane change is possible.

If a lane change is possible, the method 700 may initiate 714 a lane change. Initiating 714 a lane change may include, for example, signaling a lane change, increasing the speed of the autonomous vehicle 100, and changing the angle or direction of vehicle 100 travel. If a lane change is not possible, a safety response may be initiated 716. A safety response may include, for example, decreasing the speed of the autonomous vehicle 100, increasing or maintaining distance between the autonomous vehicle 100 and the bus 104, selecting an alternate travel route for the autonomous vehicle 100, and/or performing or increasing the frequency of pedestrian detection algorithms performed to detect and/or avoid pedestrians.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising:
detecting a bus;
obtaining image data from the bus, the image data including information displayed on the bus;
processing, via a deep neural network, the information to associate the bus with a route having at least one stop;
obtaining map data corresponding to the at least one stop; and
initiating at least one of a lane change and a safety response in response to proximity of the bus to the stop.

2. The method of claim 1, wherein detecting a bus further comprises identifying, via a deep neural network, a bus type corresponding to the bus.

3. The method of claim 2, wherein the bus type is selected from the group consisting of a public transit bus, a private charter bus, a shuttle bus, and a school bus.

4. The method of claim 1, wherein detecting a bus further comprises processing data from at least one sensor.

5. The method of claim 4, wherein the at least one sensor is selected from the group consisting of a camera sensor, a lidar sensor, a radar sensor, a GPS sensor, and an ultrasound sensor.

6. The method of claim 4, wherein the at least one sensor is coupled to an autonomous vehicle.

7. The method of claim 1, wherein obtaining image data comprises gathering image data from a camera.

8. The method of claim 1, wherein the deep neural network is trained on at least one image selected from the group consisting of a bus code, a bus number, a route description, and a license plate number.

9. A system comprising:
at least one processor; and
at least one memory device coupled to the at least one processor and storing instructions for execution on the at least one processor, the instructions causing the at least one processor to:
detect a bus;
obtain image data from the bus, the image data including information displayed on the bus;
process, via a deep neural network, the information to associate the bus with a route having at least one stop;
obtain map data corresponding to the at least one stop; and
initiate at least one of a lane change and a safety response in response to proximity of the bus to the stop.

10. The system of claim 9, wherein detecting a bus further comprises identifying, via a deep neural network, a bus type corresponding to the bus.

11. The system of claim 10, wherein the bus type is selected from the group consisting of a public transit bus, a private charter bus, a shuttle bus, and a school bus.

12. The system of claim 9, wherein detecting a bus further comprises processing data from at least one sensor.

13. The system of claim 12, wherein the at least one sensor is selected from the group consisting of a camera sensor, a lidar sensor, a radar sensor, a GPS sensor, and an ultrasound sensor.

14. The system of claim 12, wherein the at least one sensor is coupled to an autonomous vehicle.

15. The system of claim 9, wherein obtaining image data comprises gathering image data from a camera.

16. The system of claim 9, wherein the deep neural network is trained on at least one image selected from the group consisting of a bus code, a bus number, a route description, and a license plate number.

17. A computer program product for avoiding traffic interference from a bus, the computer program product comprising a computer-readable storage medium having computer-usable program code embodied therein, the computer-usable program code configured to perform the following when executed by at least one processor:
(1) detect a bus;
(2) obtain image data from the bus, the image data including information displayed on the bus;
(3) process, via a deep neural network, the information to associate the bus with a route having at least one stop;
(4) obtain map data corresponding to the at least one stop; and
(5) initiate at least one of a lane change and a safety response in response to proximity of the bus to the stop.

18. The computer program product of claim 17, wherein detecting a bus further comprises identifying, via a deep neural network, a bus type corresponding to the bus.

19. The computer program product of claim 17, wherein detecting a bus further comprises processing data from at least one sensor.

20. The computer program product of claim 19, wherein the at least one sensor is selected from the group consisting of a camera sensor, a lidar sensor, a radar sensor, a GPS sensor, and an ultrasound sensor.
